(19) United States
(12) Patent Application Publication
(10) Pub. No.: US 2012/0269642 A1
(43) Pub. Date: Oct. 25, 2012

(54) METHOD FOR FUSION WELDING A MONOCRYSTALLINE WORKPIECE TO A POLYCRYSTALLINE WORKPIECE AND ROTOR

(75) Inventor: Marcus Klemm, Germering (DE)

(73) Assignee: MTU AERO ENGINES GMBH, Munchen (DE)

(21) Appl. No.: 13/500,445

(22) PCT Filed: Oct. 2, 2010
(86) PCT No.: PCT/DE10/01168

§ 371 Date: Jun. 27, 2012

(30) Foreign Application Priority Data
Oct. 10, 2009 (DE) 10 2009 048 957.6

(51) Int. Cl. B23K 26/20; F03B 3/12

(52) U.S. Cl. 416/223 R; 219/121.64

(57) ABSTRACT

A method for fusion welding a metal workpiece, which has a monocrystalline structure, to a metal workpiece, which has a polycrystalline structure, using a fiber laser and producing an I seam, is disclosed. A rotor produced according to the method is also disclosed.

This application claims the priority of International Application No. PCT/DE2010/001168, filed Oct. 2, 2010, and German Patent Document No. 10 2009 048 957.6, filed Oct. 10, 2009, the disclosures of which are expressly incorporated by reference herein.

### BACKGROUND AND SUMMARY OF THE INVENTION

The invention relates to a method for the adhesive connection of a monocrystalline workpiece to a polycrystalline workpiece and a rotor of a turbomachine having at least one blade row produced according to such a method.

Monocrystalline structures and polycrystalline, directionally solidified structures, for example made of a super alloy with a high nickel or cobalt content like Inconel 718, are not considered to be fusion weldable due to their high y′ content. Workpieces having these types of structures are therefore frequently connected to one another via adhesive methods in which there is no molten phase which could lead to recrystallization and therefore to the formation of dangerous crack-initiating grain boundaries. Thus, in German Patent Application DE 10 2005 019 356 A1 for example, the applicant proposes producing a turbine blisk by connecting a monocrystalline rotor blade to a rotor disk by means of a friction welding method. In German Patent Application DE 10 2007 050 142 A1, the applicant proposes producing a turbine blisk by providing a monocrystalline rotor blade with a blade root that is suitable for fusion welding. DE 10 2005 021 642 B4 proposes producing a monocrystalline turbine blade from a plurality of polycrystalline molded bodies, wherein exact solidification conditions must be adhered to. Soldering these types of materials to one another is also known, however, the soldering does not guarantee high-temperature strength.

In the recent past, however, fusion welding even in the case of monocrystalline super alloys has established itself in the field of deposition welding. Thus, DE 60 2004 002 203 T2 proposes filling chips in damaged shrouds by means of a YAG laser and a welding powder made of the shroud material, in this case Inconel 713. EP 1 808 572 A1, for example, proposes sealing cracks in turbine blades by using a welding filler material with non-optimal mechanical properties, which is subsequently adjusted to an optimal material composition by a diffusion process. However, the use of welding filler materials is laborious and error-prone due to the precise composition and metering. Furthermore, these fusion welding processes do not permit the adhesive and crack-free joining of monocrystalline materials to polycrystalline materials for example.

For crack-free welding of metal components DE 10 2006 048 580 proposes conducting a local temperature application using two temperature fields running parallel or almost parallel to the welding direction and generated electromagnetically in the interior of the components extending longitudinally to the welding direction.

EP 1 512 838 A2 is also mentioned for the sake of completeness, which, though it does not make a contribution to fusion weldability of monocrystalline structures, it shows, however, that the chips mentioned in the aforementioned DE 60 2004 002 203 T2 can be avoided by intermediate pieces, which are arranged loosely in side pockets between the shrouds so that the shrouds cannot rub or hit against each other.

In contrast, the object of the invention is creating a method for the adhesive connection of monocrystalline workpieces to polycrystalline workpieces, which eliminates the aforementioned disadvantages in particular those relating to high-temperature strength and to welding filler materials, and does not cause any crack initiation. The further object of the invention is creating a rotor of a turbomachine produced in said manner.

A method according to the invention for the adhesive joining of a monocrystalline workpiece to a polycrystalline workpiece provides for producing the workpieces of a super alloy, in particular a nickel-based alloy. Then the workpieces are positioned in a butt joint with one another. Finally, the workpieces are fusion welded to each other using a fiber laser.

The fiber laser in combination with the butt joint and an I seam that forms in the process make fusion welding of both of the workpieces possible without the formation of dangerous and crack-initiating grain boundaries, wherein residual stress caused by the welding is better distributed over the I seam. The workpieces are directly connected to one another so that welding fillers materials are not required and the fusion welding process is simple to control or regulate. The method according to the invention makes an adhesive connection of the workpieces that is easy on the structure possible, a connection that is able to thereby handle the greatest mechanical, chemical and physical stress such as those that may occur in the hot-gas path of gas turbines of turbomachines for example. A reduced fatigue strength for example or a limited high-temperature strength such as in the case of soldered connections of the joined workpieces is not to be feared when using the method according to the invention.

A preferred material for the monocrystalline workpiece is the lightweight monocrystalline alloy LEK 94 and Inconel 718 for the polycrystalline material. These types of materials are established in particular in the case of gas turbines or for aircraft engines so that the method according to the invention may be used there in a targeted manner. However, other nickel-based alloys such as, for example, Inconel 713, are conceivable.

In the case of one exemplary embodiment, the butt joint is designed with a thickness within the limits of approximately 1 mm to 2 mm. The workpieces are hereby uniformly heated over their cross sections in the butt joint region and great temperature differences or temperature stress cannot occur or be initiated.

A pulsed fiber laser is preferably used. These types of lasers have in particular a high beam quality and a high degree of efficiency. With one exemplary embodiment, the fiber laser is adjusted to a welding power of approximately 800 W to 1300 W. In this case, a high welding quality can be achieved if the laser beam is moved along the butt joint relative to the workpieces at a welding speed of approximately 2 m/min to 6 m/min, in particular 4 m/min.

In order to keep the laser beam from fanning out unacceptably, the laser beam is preferably moved orthogonally to the butt joint. The laser beam is overfocused, underfocused or sharply focused as a function of the process parameters, such as materials, material thickness and welding power. For example, an overfocussing and an underfocussing by approximately 5 mm respectively are adjustable.

Helium is conceivable as the inert gas. This allows for a high welding quality and is relatively simple in terms of handling.

A rotor according to the invention for a turbomachine has at least one blade row, which has a plurality of monocrystalline blades each having a shroud made of a super alloy. A polycrystalline intermediate piece made of a super alloy is arranged respectively between adjacent shrouds and the intermediate piece is connected adhesively to the shrouds via a method according to the invention.

The advantage of the fusion welded joint according to the invention is that the intermediate pieces are also firmly positioned between the shrouds even at high temperatures and high mechanical stress. The contour of the intermediate pieces may be optimally adapted to the shrouds so that flow and leakage losses are prevented in the shroud region of the blades.

The shrouds and the intermediate pieces are preferably made of a nickel-based alloy. Examples of this are the light monocrystalline alloy LEK 94 for the shroud and Inconel 718 for the intermediate piece. These materials are ideally adapted to the conditions within a gas turbine.

Other advantageous exemplary embodiments of the invention are the subject matter of further dependent claims.

Preferred exemplary embodiments of the invention will be explained in greater detail in the following on the basis of schematic representations.

### BRIEF DESCRIPTION OF THE DRAWINGS

FIG. 1 is a side view of two to-be-joined workpieces in accordance with a first exemplary embodiment according to the invention,

FIG. 2 illustrates the workpieces from FIG. 1 after the fusion welding according to the invention,

FIG. 3 is a side view of two to-be-joined workpieces according to a second exemplary embodiment according to the invention,

FIG. 4 is a partial view of a rotor according to the invention prior to performing a fusion welding process according to the invention, and

FIG. 5 illustrates the rotor from FIG. 4 after the fusion welding.

### DETAILED DESCRIPTION OF THE DRAWINGS

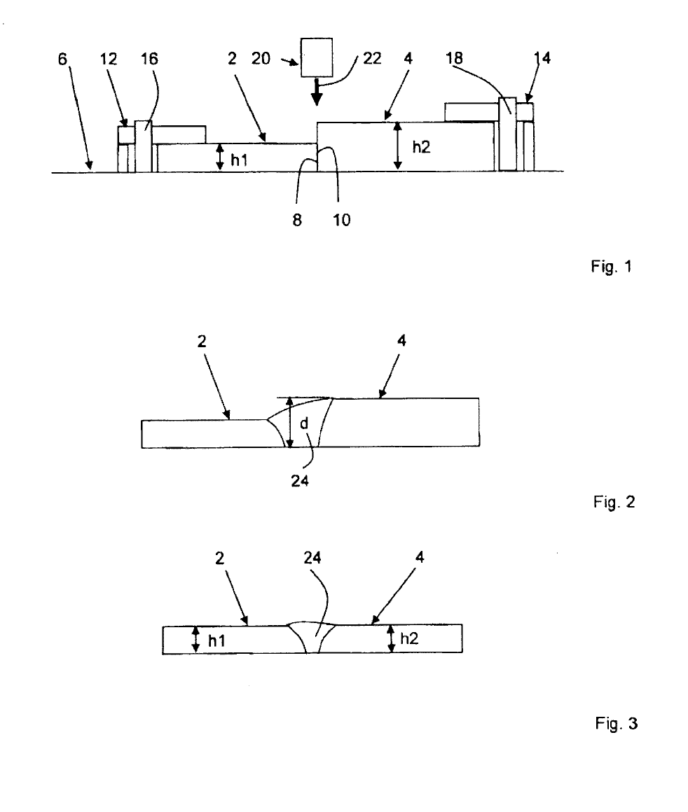

FIG. 1 shows a metal workpiece 2 with a monocrystalline structure and a metal workpiece 4 with a polycrystalline structure, which are to be welded to one another using the method according to the invention. The workpieces 2, 4 are configured as rectangular thin sheet metal with an approximate height of h1=1.27 mm or h2=1.59 mm. An I seam 24 shown in FIG. 2 with a thickness d between 1 mm to 2 mm forms correspondingly. The workpieces 2, 4 are made of a nickel-based alloy, wherein the monocrystalline workpiece 2 features the material LEK 94 and the polycrystalline workpiece 4 features the material Inconel 718.

The two workpieces 2, 4 are positioned on a work bench 6 and form a butt joint so that their joining surfaces 8, 10 lie flat against each other. They are respectively clamped on the work bench 6 via a clamping device 12, 14 having a spindle drive 16, 18, which engages on the edge sections of the workpieces that are away from the butt joint.

The fusion welding of the two workpieces 2, 4 is performed using a fiber laser 20, which emits a laser beam 22 directed at the butt joint. The fiber laser 20 is designed as a pulsed laser with a maximum power of 2 kW.

During the fusion welding of the two workpieces 2, 4 according to the invention, the laser beam 22 is moved along the butt joint relative to the workpieces at a feed rate of approximately 4 m/min. The preferred welding power in this case is approximately 40% to 60% of its maximum power of 2 kW, i.e., 800 W to 1300 W. In the process, the welding power may be increased or reduced in a variable manner at the beginning and end of the welding process in order to prevent seam defects, such as craters at the beginning and end of welds. Its welding angle in the feed direction and in the transverse direction of the butt joint is preferably 90 degrees. As a result, the laser beam 22 is directed orthogonally to the butt joint. Its focus position is adapted to the different heights h1, h2 of the workpieces 2, 4 and may be overfocused or underfocused by approximately 5 mm. Helium with a through-put of approximately 4 l/min is used as the inert gas. As FIG. 2 shows, the workpieces 2, 4 are firmly connected to each other after the fusion welding via the crack-free I seam 24.

According to the depiction in FIG. 3, it is also possible according to the invention to connect metal monocrystalline workpieces 2 and metal polycrystalline workpieces 4 having the same height h1=h2 to one another in a butt joint using a fiber laser (not shown) in a fusion welding process, wherein, depending upon the materials and the heights h1, h2, an adaptation of the aforementioned welding parameters must take place to form an I seam 24 that reduces the welding stress.

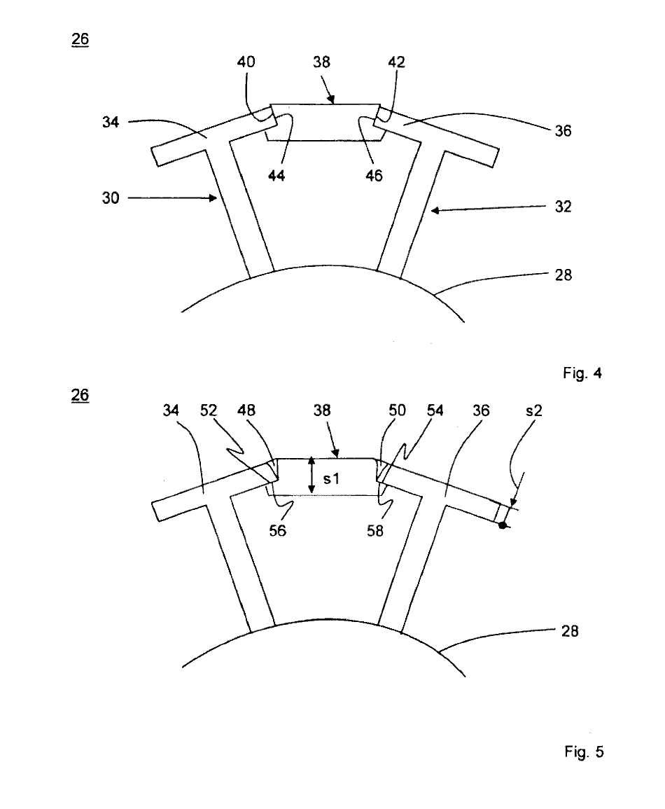

FIG. 4 shows a partial section of a turbomachine rotor 26 according to the invention. The rotor 26 is a so-called turbine blisk, on whose outer circumference 28 a plurality of blades 30, 32 arranged side-by-side in the circumferential direction are integrally fastened or configured. However, in the application, the term rotor 26 is also understood to include an integrally bladed rotor ring (bling).

The blades 30, 32 are fastened on the root side on the outer circumference 28 via a friction welding method, however, they may also already be configured thereon during the production of the rotor 26. They are made of a nickel-based alloy, preferably LEK 94 and have a monocrystalline structure. They respectively have an integrally configured and radially outer shroud 34, 36. Adjacent shrouds 34, 36 are spaced apart from one another via a respective metal intermediate piece 38.

The intermediate piece 38 has a polycrystalline structure and is made of the nickel-based alloy Inconel 718. It has a T-shaped cross section with two stepped surfaces 40, 42 running opposite from each other, by means of which surfaces it is connected to the opposite stepped surfaces 44, 46 of the shrouds 34, 36 using the fusion welding method according to the invention. In other words, the stepped surfaces 40, 42 and the opposite stepped surfaces 44, 46 are positioned in the butt joint and joined to one another using a fiber laser (not shown) so that the crack-free I seams 48, 50 shown in FIG. 5 are formed between them. The intermediate piece 38 has a greater wall thickness s1 than that of the shrouds 34, 36 with s2. For simplified positioning, the intermediate piece 38 is situated with its shoulder surfaces 52, 54 in contact with the shroud surfaces 56, 58 of the shrouds 34, 36 that face the outer circumference 28.

It should be noted that the method described here is not restricted to thin sheet metal, but that, when using the teachings according to the invention described here, even thicker walled monocrystalline workpieces 2 are able to be connected to polycrystalline workpieces 4 in a fusion welding process.

The invention discloses a method for fusion welding a metal workpiece 2, which has a monocrystalline structure, to a metal workpiece 4, which has a polycrystalline structure, using a fiber laser 20 and producing an I seam 24 as well as a rotor 26 produced according to said method.

1.-14. (canceled)

15. A method for adhesive connection of a metal workpiece, which has a monocrystalline structure, to a metal workpiece, which has a polycrystalline structure, wherein both of the metal workpieces are a respective super alloy, comprising the steps of:
positioning both of the metal workpieces in a butt joint with one another; and
fusion welding both of the metal workpieces using a fiber laser.

16. The method according to claim 15, wherein a material of the monocrystalline structure is LEK 94 and wherein a material of the polycrystalline structure is Inconel 718.

17. The method according to claim 15, wherein the butt joint has a thickness of 1 mm to 2 mm.

18. The method according to claim 15, wherein the step of fusion welding using the fiber laser includes the step of pulsing the fiber laser.

19. The method according to claim 15, wherein the step of fusion welding using the fiber laser includes the step of adjusting the fiber laser to a welding power of approximately 800 W to 1300 W.

20. The method according to claim 15, wherein the step of fusion welding using the fiber laser includes the step of moving a laser beam of the fiber laser along the butt joint relative to both of the metal workpieces at a speed of approximately 2 m/min to 6 m/min.

21. The method according to claim 15, wherein the step of fusion welding using the fiber laser includes the step of moving a laser beam of the fiber laser orthogonally to the butt joint.

22. The method according to claim 15, wherein the step of fusion welding using the fiber laser includes the step of overfocussing a laser beam of the fiber laser.

23. The method according to claim 15, wherein the step of fusion welding using the fiber laser includes the step of underfocussing a laser beam of the fiber laser.

24. The method according to claim 15, wherein the step of fusion welding using the fiber laser includes the step of sharply focusing a laser beam of the fiber laser.

25. The method according to claim 15, wherein the step of fusion welding using the fiber laser includes the step of using a helium-like inert gas.

26. The method according to claim 15, wherein the metal workpiece which has a monocrystalline structure is a rotor blade with a shroud of a rotor of a turbomachine and wherein the metal workpiece which has a polycrystalline structure is an intermediate shroud piece.

27. The method according to claim 15, wherein the step of fusion welding using the fiber laser forms an I seam at the butt joint.

28. A rotor for a turbomachine, comprising:
a blade row with a plurality of monocrystalline blades, wherein each of the plurality of blades has a respective shroud, made of a super alloy;
a plurality of polycrystalline intermediate shroud pieces made of a super alloy respectively disposed between adjacent shrouds of the plurality of monocrystalline blades;
wherein the plurality of polycrystalline intermediate shroud pieces respectively disposed between the adjacent shrouds of the plurality of monocrystalline blades are each adhesively connected to the adjacent shrouds by a respective fusion welded I seam at a butt joint.

29. The rotor according to claim 28, wherein the shrouds and the intermediate shroud pieces are made of a nickel-based alloy.

30. The rotor according to claim 28, wherein a material of the shrouds is LEK 94 and wherein a material of the intermediate shroud pieces is Inconel 718.
